(19) United States
(12) Patent Application Publication
(10) Pub. No.: US 2017/0164049 A1
(43) Pub. Date: Jun. 8, 2017

(54) RECOMMENDING METHOD AND DEVICE THEREOF

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Rui WANG, Tianjin (CN); Weisen TIAN, Tianjin (CN); Lei GENG, Tianjin (CN)

(21) Appl. No.: 15/249,289

(22) Filed: Aug. 26, 2016

Related U.S. Application Data
(63) Continuation of application No. PCT/CN2016/089352, filed on Jul. 8, 2016.

(30) Foreign Application Priority Data
Dec. 2, 2015 (CN) 201510880599.7

(51) Int. Cl. H04N 21/4415; G10L 17/02; G10L 17/04; H04N 21/45; H04N 21/482; H04N 21/442; H04N 21/439; G10L 17/06; H04N 21/466

(52) U.S. Cl. CPC H04N 21/4415; G10L 17/06; G10L 17/02; G10L 17/04; H04N 21/4668; H04N 21/482; H04N 21/44222; H04N 21/4394; H04N 21/4532

(57) ABSTRACT

An embodiment of the present disclosure discloses a recommending device and a method thereof, wherein the method specifically comprises: collecting voice data of a current user; extracting voiceprint features of the voice data; identifying the current user according to the voiceprint features; acquiring program contents to be recommended to the current user according to behavioral habit features of the current user; wherein the behavioral habit features comprise: relative attributes of historical program contents obtained according to analysis of historical behavior data of the user; and displaying the program contents on a smart TV. The embodiment of the present disclosure can increase the accuracy of the recommended program contents.

### CROSS-REFERENCE TO RELATED APPLICATIONS

This application is a continuation of International Application No. PCT/CN2016/089352 filed on Jul. 8, 2016, which is based upon and claims priority to Chinese Patent Application No. 201510880599.7, entitled “RECOMMENDING METHOD AND DEVICE THEREOF”, filed on Dec. 2, 2015, the entire contents of all of which are incorporated herein by reference.

### TECHNICAL FIELD

The present disclosure generally relates to the field of smart TV, and particularly to a recommending device and a method thereof.

### BACKGROUND

As the television set becomes increasingly intelligent and popularized, the smart TV has become a common household appliance, and most can recommend program contents to the user.

During the process of achieving the present disclosure, the inventor found that an existing recommendation scheme is to acquire the browsing history in the smart TV after the smart TV powers on and analyze the user's usage behavior data according to the acquired browsing history, acquire program contents that match with the above described usage behavior data, and recommend the program contents to the user.

However, there tends to be a one-to-multiple relations between the smart TV and the users, i.e., one smart TV is generally used by multiple users, and thus, in the implementation of the existing recommendation scheme by analyzing the browsing history in the smart TV after the smart TV powers on and recommending program contents that match with the analysis result to the current user, there will be the following case: the browsing history recorded in the smart TV may be based on multiple users, but the current user of the smart TV is user B, then the program contents that the smart TV recommends to the user B actually contain program contents that are preferred by multiple users, which may include those that this user does not like, thereby resulting in low accuracy of the recommended program contents.

### SUMMARY

An embodiment of the present disclosure discloses a recommending device and a method thereof to solve the shortcoming of low accuracy of recommended program contents in the existing recommendation scheme and increase the accuracy of the program content recommendation.

According to an embodiment of the present disclosure, there is provided a recommending method, comprising:

at an electronic device:

collecting voice data of a current user;

extracting voiceprint features of voice data;

identifying the current user according to the voiceprint features;

acquiring program contents to be recommended to the current user according to behavioral habit features of the current user; wherein the behavioral habit features comprise: relative attributes of historical program contents obtained according to analysis of historical behavior data of the user; and

displaying the program contents on a smart TV.

According to an embodiment of the present disclosure, there is provided an electronic device, comprising: at least one processor; and a memory communicably connected with the at least one processor for storing instructions executable by the at least one processor, wherein execution of the instructions by the at least one processor causes the at least one processor to:

collect voice data of a current user:

extract voiceprint features of voice data;

identify the current user according to the voiceprint features;

acquire program contents to be recommended to the current user according to behavioral habit features of the current user, wherein, the behavioral habit features comprise: relative attributes of historical program contents obtained according to analysis of historical behavior data of the user; and

display the program contents on a smart TV.

According to an embodiment of the present disclosure, there is provided a non-transitory computer-readable medium storing executable instructions that, when executed by an electronic device with a touch-sensitive display, cause the electronic device to: collect voice data of a current user, extract voiceprint features of voice data; identify the current user according to the voiceprint features; acquire program contents to be recommended to the current user according to behavioral habit features of the current user, wherein, the behavioral habit features comprise: relative attributes of historical program contents obtained according to analysis of historical behavior data of the user; and display the program contents on a smart TV.

The recommending device and the method thereof disclosed in the embodiment of the present disclosure can identify the current user according to the voiceprint features extracted from the voice data of the current user, thereby recommending the current user of the smart TV program contents that match with his/her behavioral habit features, and in contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preference according to their behavioral habit features, and therefore can increase the accuracy of the recommended program contents.

Assuming there are five family members in a family and user B is currently using the smart TV, then the existing recommendation scheme tends to acquire and recommend program contents for the current user according to historical behavior data stored locally, wherein the above described historical behavior data stored locally is obtained based on the behavioral operations of the five family members, while the embodiment of the present disclosure can identify that the current user is user B according to the voiceprint features, and then acquire and recommend program contents according to the behavioral habit features obtained based on the analysis of the historical behavior data of user B, so the embodiment of the present disclosure can increase the accuracy of the recommended program contents.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a recommending method in accordance with some embodiments.

FIG. 2 is a step flowchart of a recommending method in accordance with some embodiments.

FIG. 3 is a schematic structural diagram of a recommending device in accordance with some embodiments.

FIG. 4 is a schematic structural diagram of a recommending device in accordance with some embodiments.

FIG. 5 is a schematic structural diagram of a recommending device in accordance with some embodiments.

FIG. 6 is a schematic structural diagram of a recommending device in accordance with some embodiments.

FIG. 7 is a schematic structural diagram of a recommending device in accordance with some embodiments.

FIG. 8 is a schematic structural diagram of a recommending device in accordance with some embodiments.

FIG. 9 is a schematic structural diagram of a recommending device in accordance with some embodiments.

FIG. 10 schematically shows a block diagram of an electronic device for executing the method according to the present disclosure.

FIG. 11 schematically shows a storage unit for retaining or carrying program code for realizing the method according to the present disclosure.

### DETAILED DESCRIPTION

For the purpose of clarifying the objects, technical schemes and advantages of an embodiment of the present disclosure, a clear and complete description will be made to technical schemes of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by a person skilled in the art without undertaking creative work fall within the protection scope of the present disclosure.

### Method Embodiment I

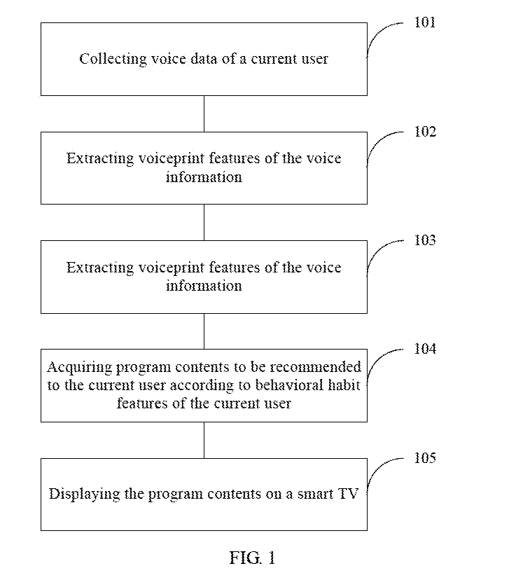

With reference to FIG. 1, it shows a step flowchart of a recommending method according to a first embodiment of the present disclosure, which in particular may include the steps as follows.

Step 101, collecting voice data of a current user.

The embodiment of the present disclosure can be applied to an application scenario of smart TV, to recommend program contents that match with the user's preference to the user via the smart TV accurately.

In the embodiment of the present disclosure, the above described voice data may be any voice data received by a voice collecting device in voice data receiving range, for example, a power-on voice instruction sent by the user to the smart TV or any voice data said by the user that can be received by the smart TV.

Step 102, extracting voiceprint features of the voice data.

In the embodiment of the present disclosure, the above described voiceprint features, in particular, may include at least one of the following voiceprint features: frequency spectrum, MFCC (Mel Frequency Cepstrum Coefficient), LPC (linear prediction cepstrum coefficient), MVDR (Minimum Variance Distortionless Response), formant, fundamental tone, reflection coefficient, voiceprint diagram and the like, wherein the above mentioned voiceprint diagram may be a spectrum diagram obtained by transforming the voice data into changes of strength, wavelength, frequency and cadence of an electric signal and depicting the above changes of the electric signal.

In an optional embodiment of the present disclosure, the voice data of the current user can be collected and the voiceprint features can be extracted from the above collected voice data by a DSP (Digital Signal Processor); in particular, the above-mentioned DSP can realize the collection of the voice data of the current user by a microphone, and it can be appreciated that, the embodiment of the present disclosure does not limit the specific way of collecting the voice data.

The above technical solution of collecting the voice data of the current user and extracting the voiceprint features by a DSP can be applied to application scenarios where the smart TV is in a power-off state, a power-on state and the like. On one hand, since the DSP is a hardware means, collecting the voice data of the user and extracting the voiceprint features using the DSP is characterized by higher performing speed and more accurate performing result; on the other hand, when the smart TV is in a power-off state, the voice data can be collected and the voiceprint features can be extracted by the DSP, saving time for performing the above operations after the smart TV powers on, to allow the smart TV to identify the user according to the voiceprint features more timely.

In another optional embodiment of the present disclosure, when the smart TV is in a power-on state, operations such as collecting the voice data of the current user and extracting voiceprint features from the above collected voice data can be performed by an application installed on the smart TV, wherein the above application may be a software application with corresponding functions of collecting voice data and extracting voiceprint features and the like. This optional embodiment can save the hardware cost corresponding to the DSP.

Step 103, identifying the current user according to the voiceprint features.

In the embodiment of the present disclosure, since voiceprint features of each person are different from one another, users can be labeled by voiceprint features, i.e., the current user can be identified by voiceprint features.

The embodiment of the present disclosure can provide the following technical solutions of identifying the current user according to the voiceprint features.

### Technical Solution I

In technical solution I, the step of identifying the current user according to the voiceprint features in particular may include: searching for a user corresponding to the voiceprint features in a voiceprint database according to the voiceprint features; wherein the voiceprint database is stored with a mapping relation between the user and the voiceprint features.

In the embodiment of the present disclosure, by receiving the input voice data, the voiceprint features of the user can be extracted and the mapping relation between the user and the voiceprint features can be established in the voiceprint database, wherein the approach of establishing the mapping relation between the user and the voiceprint features in the voiceprint database may specifically include: Approach I, the user provides voiceprint features and user ID via the user identification registration interface in the smart TV to allow the smart TV to store the mapping relation between the user and the voiceprint features in the voiceprint database; thus, if the current user is a user having storage record in the voiceprint database, the smart TV executes step 104 to recommend program contents to the user.

Approach II, the user ID is set as an auto-increment primary key in the voiceprint database, so that when the voiceprint features are added to the voiceprint database, the user ID associated with the voiceprint features can be determined in an auto-increment way, thereby storing the mapping relation between the user and the voiceprint features in the voiceprint database, for example: after voice data of user A is received by a voice receiving device of the smart TV, a mapping relation between the voiceprint features of user A and the auto-increment user ID: 02 can be added to the voiceprint database; after voice data of user B is received by the voice receiving device of the smart TV, a mapping relation between the voiceprint features of user B and the auto-increment user ID: 03 can be further added to the voiceprint database; in this way, if the current user is a user that has storage record in the voiceprint database, the smart TV executes step 104 to recommend program contents to the current user if the current user has no corresponding storage record in the voiceprint database, a mapping relation between the voiceprint features of the current user and the auto-increment user ID is established in the voiceprint database, so that the mapping relation between the user and the voiceprint features is stored in the voiceprint database.

### Technical Solution II

In technical solution I, the above described step of identifying the current user according to the voiceprint features in particular may include steps as follows.

Step S1, inputting the above voiceprint features to a user's voiceprint feature model, and outputting, by the voiceprint feature model, a matching degree of the voiceprint features and the voiceprint feature model; wherein the voiceprint feature model is a model obtained according to user's voice data training.

Step S2, determining a user corresponding to a voiceprint feature model that has a highest matching degree with the voiceprint features as the current user.

In an application example of the present disclosure, assuming the above said voiceprint feature model is an HMM (Hidden Markov Model) model, the smart TV is stored with five voiceprint feature models of five members in a family, which are voiceprint feature model 1 to voiceprint feature model 5 respectively; the smart TV collects voice data of the current user and extracts voiceprint features from the voice data and inputs the voiceprint features to the voiceprint feature model 1 to voiceprint feature model 5, and then the voiceprint feature model having the largest output result among the voiceprint feature model 1 to voiceprint feature model 5 is the voiceprint feature model having the highest matching degree with the aforesaid voiceprint features, and then it can be determined that this voiceprint feature model is the voiceprint feature model corresponding to the current user, and then the user associated with the above said voiceprint feature model can be found in the voiceprint model database according to this voiceprint feature model, and this user is determined as the current user; wherein the aforesaid voiceprint model database can be stored with mapping relations between users and voiceprint feature models.

It can be appreciated that the above described voiceprint feature model, being an HMM model, is only an example of the voiceprint feature model in the embodiment of the present disclosure, and shall not be interpreted as a limitation of the above described voiceprint feature model in the embodiment of the present disclosure, and as a matter of fact, the voiceprint feature model may include various categories such as GMM (Gaussian Mixture Model) model, polynomial classifier model and so on, i.e., the embodiment of the present disclosure does not specifically limit the voiceprint feature model.

Step 104, acquiring program contents to be recommended to the current user according to behavioral habit features of the current user.

In an optional embodiment of the present disclosure, user's behavioral habit features corresponding to the current user can be searched for in a behavioral habit database according to the current user; wherein the above said behavioral habit database is stored with a mapping relation between the user and the behavioral habit features; or, user's behavioral habit feature model corresponding to the current user can be searched for in a behavioral habit model database according to the current user; wherein the behavioral habit model database is stored with a mapping relation between the user and behavioral habit feature model.

In the embodiment of the present disclosure, the step of storing the mapping relation between the user and the behavioral habit features in the behavioral habit database in particular may include steps as follows.

Step A1, after identifying, by the smart TV, the current user according to the voiceprint features, obtaining the behavioral habit features according to historical behavior data of the current user.

Step A2, establishing the mapping relation between the user and the behavioral habit features in the behavioral habit database.

In the embodiment of the present disclosure, during the use of the smart TV, the current user can be identified according to the voiceprint features of the collected voice data, and thereby the user ID of the current user is acquired, and when the current user performs operations with respect to the smart TV, historical behavior data produced by the above operations is analyzed to obtain the user's behavioral habit features from the analysis of the historical behavior data, and then the behavioral habit features are stored in the behavioral habit database and are associated with the user ID of the current user, to realize storing the mapping relation between the behavioral habit features and the user in the behavioral habit database; or, after the current user is identified, analysis training is performed on the historical behavior data of the current user to obtain the behavioral habit feature model, and the behavioral habit feature model is stored in the behavioral habit model database and matched with the user ID of the current user, to realize storing the mapping relation between the behavioral habit features model and the user in the behavioral habit model database.

In the embodiment of the present disclosure, after the current user is identified according to the voiceprint features, the user ID can be acquired from the above described voiceprint feature database or the voiceprint feature model database, and then user's behavioral habit features corresponding to the above user ID can be found in the behavioral habit database or the behavioral habit model database according to the above user ID, to recommend program contents to the current user according to the found behavioral habit features or behavioral habit feature model.

In the embodiment of the present disclosure, the above described behavioral habit features in particular may be relative attributes of historical program contents acquired by analysis of the user's historical behavior data, such as the type of watched historical program contents, episodes of watched historical program contents, relative actors and actresses of followed historical program contents and other attributes acquired by the analysis of the historical behavior data; the above described behavioral habit feature model in particular may include: a relative model of the behavioral habit features based on historical behavior data training of the user, such as SVD (Singular Value Decomposition) model, FM (Factorization Machine) model, NFM (Non-negative Matrix Factorization) model and the like based on the historical behavior data training of the user, after the current user is identified according to the above said voiceprint features, behavior habit features associated with the current user can be searched for in the behavioral habit database or a relative model of the behavioral habit features associated with the current user can be searched for in the behavioral habit model database according to the current user, and the program contents to be recommended to the current user are obtained according to the above described behavioral habit features or the relative model of the behavioral habit features.

In an application example 1 of the present disclosure, assuming that the behavioral habit features obtained according to the analysis of user's historical behavior data include: celebrity A, celebrity B, comedy and the like, then the program contents obtained according to the behavioral habit features and to be recommended to the user may include program contents related to celebrity A, celebrity B, comedy and the like.

In an application example 2 of the present disclosure, assuming that the relative model established based on the behavioral habit features that are obtained according to the analysis of the user's historical behavior data is an SVD model then the program contents that are acquired according to the relative model of the behavioral habit features and to be recommended to the user may include program contents that are predicted by the SVD model to match with the user's preference.

Step 105, displaying the program contents on the smart TV.

In an optional embodiment of the present disclosure, the above described behavioral habit features in particular may further include basic usage habit features of the current user with respect to the smart TV, and the embodiment of the present disclosure in particular may further include steps as follows.

Step S1, acquiring parameters of the smart TV to be recommended to the current user according to the basic usage habit features of the current user.

Step S2, displaying the parameters on the smart TV.

In the embodiment of the present disclosure, the above described parameters in particular may include smart TV parameters preferred by the user such as brightness, volume, definition preference, contrast ratio and the like, and after the smart TV acquires the above said parameters, it recommends the parameters to the current user, so that the current user may obtain various smart TV parameters of his/her preference to adjust the smart TV according to these parameters, to allow the smart TV to provide service for the user in a more intelligent way.

In view of the foregoing, the recommending method disclosed in the embodiment of the present disclosure can identify the current user according to the voiceprint features extracted from the voice data of the current user, thereby recommending the current user of the smart TV program contents that match with his/her behavioral habit features. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

Assuming there are five family members in a family and user B is currently using the smart TV, the existing recommendation scheme acquires and recommends program contents for the current user according to historical behavior data stored locally, wherein the above described historical behavior data is obtained based on the behavioral operations of the five family members; the embodiment of the present disclosure can identify that the current user is user B according to the voiceprint features, and then acquire and recommend program contents for user B according to the behavioral habit features obtained according to the analysis of the historical behavior data of user B, so the embodiment of the present disclosure can increase the accuracy of the recommended program contents.

### Method Embodiment II

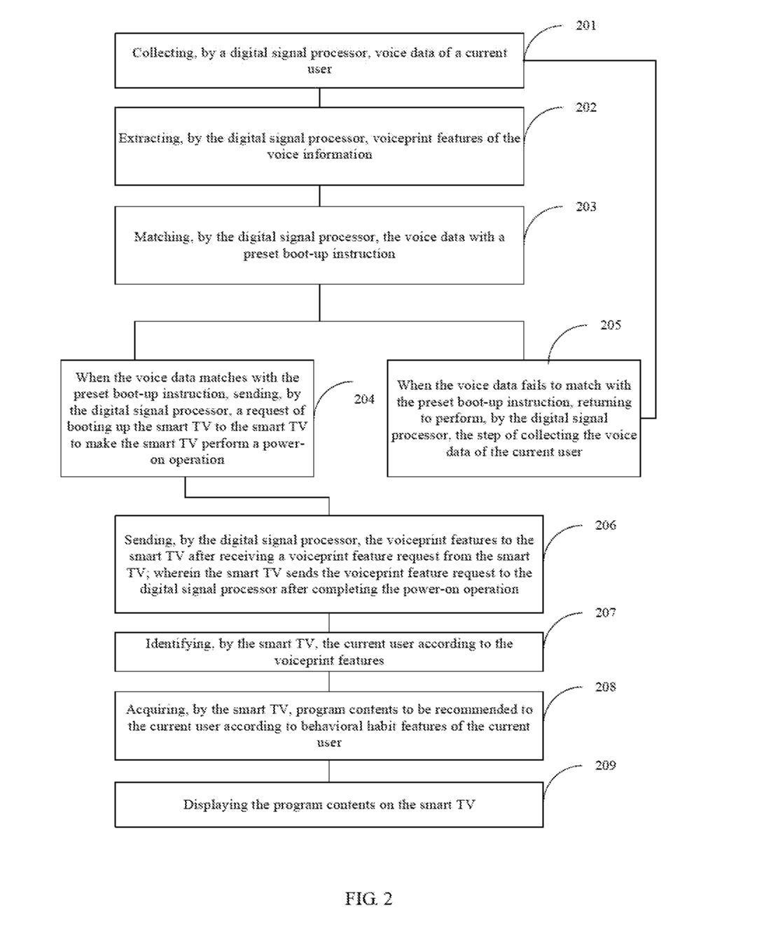

With reference to FIG. 2, it shows a step flowchart of a recommending method according to a second embodiment of the present disclosure, which in particular may include:

Step 201, collecting, by a digital signal processor, voice data of a current user;

Step 202, extracting, by a digital signal processor, voiceprint features of the voice data;

Step 203, matching, by the digital signal processor, the voice data with a preset boot-up instruction;

Step 204, when the voice data matches with the preset boot-up instruction, sending, by the digital signal processor, a request of booting up the smart TV to the smart ITV to make the smart TV perform a power-on operation;

Step 205, when the voice data fails to match with the preset boot-up instruction, returning to perform, by the digital signal processor, the step of collecting the voice data of the current user by the digital signal processor;

Step 206, sending, by the digital signal processor, the voiceprint features to the smart TV after receiving a voiceprint feature request from the smart TV; wherein the smart TV sends the voiceprint feature request to the digital signal processor after completing the power-on operation;

Step 207, identifying, by the smart TV, the current user according to the voiceprint features;

Step 208, acquiring, by the smart TV, program contents to be recommended to the current user according to behavioral habit features of the current user; and

Step 209, displaying the program contents on the smart TV.

In contrast to the first embodiment, the embodiment of the present disclosure employs the digital signal processor to collect the voice data of the current user and extract the voiceprint features of the voice data and further incorporates steps 203 to 206, to allow the smart TV to identify the current user initiatively after it is awakened by the voice data and performs the power-on operation, in order to recommend program contents to the identified current user.

In the embodiment of the present disclosure, the preset boot-up instruction in particular may be a set of instructions for booting up the smart TV (e.g., power on, boot up the TV, turn on the TV, etc.) pre-saved in the digital signal processor for matching with the voice data, in order to trigger the power-on operation of the smart TV. Further speaking, the embodiment of the present disclosure may match the voice data which has been converted into binary code with the binary code of the preset boot-up instruction (e.g., a wake-up word) pre-saved in the digital signal processor.

In the embodiment of the present disclosure, the collected voice data may be converted into a voice instruction in the form of binary code, and if the converted voice instruction matches with the stored preset boot-up instruction, i.e., the preset boot-up instruction contains an instruction of booting up the smart TV that matches with the above described voice instruction, then the operation of sending a request of booting up the smart TV to the smart TV is performed to make the smart TV perform the power-on operation and send the voiceprint feature request to the digital signal processor after the power-on operation, and the digital signal processor sends the voiceprint features to the smart TV after receiving the above said voiceprint feature request, to cause the smart TV to identify the current user according to the voiceprint features; if the converted voice instruction fails to match with the stored preset boot-up instruction, the process returns to the above step of collecting the voice data of the current user.

In view of the foregoing, with the recommending method disclosed in the embodiment of the present disclosure, the digital signal processor collects the voice data and extracts the voiceprint features, which allows the voice data to be collected and the voiceprint features to be extracted in a fast and accurate way; the digital signal processor determines whether the collected voice data of the current user matches with the preset boot-up instruction, and then make the smart TV perform the power-on operation when the above said voice data matches with the above said preset boot-up instruction, so that the smart TV can power on intelligently according to the voice data; and identify the current user according to the voiceprint features after performing the power-on operation, in order to recommend program contents to the current user according to the behavioral habit of the current user timely.

It needs be noted that, for the method embodiments, in order to simplify the description, they are all described as a series of action combinations, but a person skilled in the art should appreciate that, the embodiments of the present disclosure are not limited to the described order of the actions, because according to the embodiments of the present disclosure, some steps may be executed in other orders or simultaneously. Secondly, a person skilled in the art should also appreciate that, the embodiments described in the description are all preferred embodiments, actions involved may be not necessary for the embodiments of the present disclosure.

### Device Embodiment I

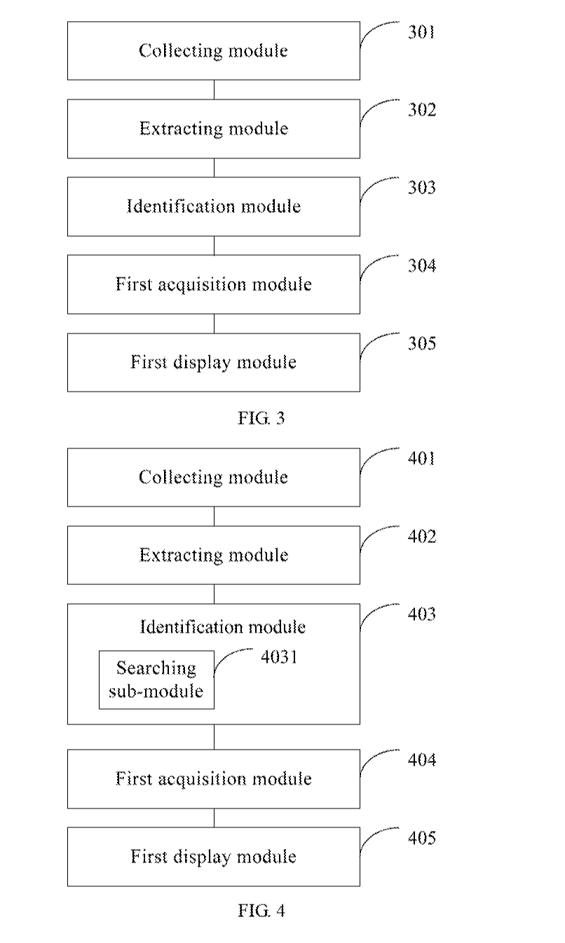

With reference to FIG. 3, it shows a schematic structural diagram of a recommending device according to a first embodiment of the present disclosure, which in particular may include: a collecting module 301, an extracting module 302, an identification module 303, a first acquisition module 304 and a first display module 305.

The collecting module 301 can be configured to collect voice data of a current user.

The extracting module 302 can be configured to extract voiceprint features of the voice data.

The identification module 303 can be configured to identify the current user according to the voiceprint features.

The first acquisition module 304 can be configured to acquire program contents to be recommended to the current user according to behavioral habit features of the current user; wherein, the behavioral habit features include: relative attributes of historical program contents obtained according to analysis of historical behavior data of the user.

The first display module 305 can be configured to display the program contents on a smart TV.

In view of the foregoing, the recommending device disclosed in device embodiment I of the present disclosure can identify the current user according to the voiceprint features extracted from the voice data of the current user, thereby recommending the current user of the smart IV program contents that match with his/her behavioral habit features. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefor can increase the accuracy of the recommended program contents.

### Device Embodiment II

With reference to FIG. 4, it shows a schematic structural diagram of a recommending device according to a second embodiment of the present disclosure, which in particular may include: a collecting module 401, an extracting module 402, an identification module 403, a first acquisition module 404 and a first display module 405.

Wherein the collecting module 401 can be configured to collect voice data of a current user.

The extracting module 402 can be configured to extract voiceprint features of the voice data.

The identification module 403 can be configured to identify the current user according to the voiceprint features.

The first acquisition module 404 can be configured to acquire program contents to be recommended to the current user according to behavioral habit features of the current user; wherein, the behavioral habit features include: relative attributes of historical program contents obtained according to analysis of historical behavior data of the user.

The first display module 405 can be configured to display the program contents on a smart TV.

Wherein the identification module 403 in particular may include:

a searching sub-module 4031, which can be configured to search for a user corresponding to the voiceprint features in a voiceprint database according to the voiceprint features; wherein the voiceprint database is stored with a mapping relation between the user and the voiceprint features.

The recommending device disclosed in the embodiment of the present disclosure can identify the current user according to the voiceprint features extracted from the voice data of the current user, thereby recommending the current user of the smart TV program contents that match with his/her behavioral habit features. Wherein the searching sub-module in the identification module can be configured to search for the user corresponding to the voiceprint features in the voiceprint database according to the voiceprint features. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefor can increase the accuracy of the recommended program contents.

### Device Embodiment III

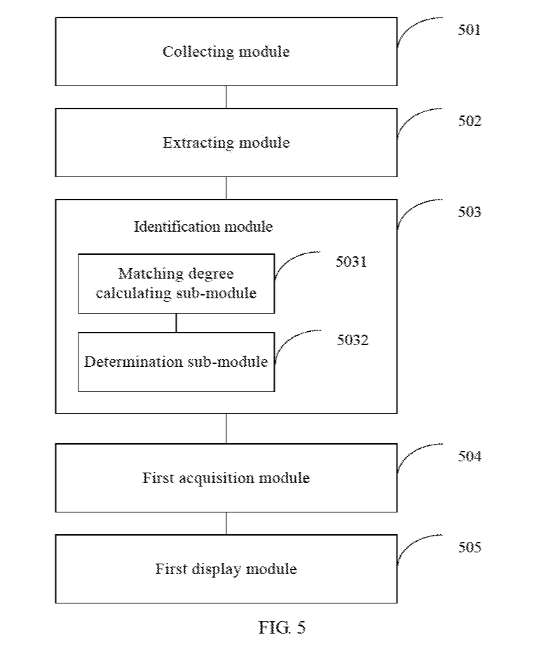

With reference to FIG. 5, it shows a schematic structural diagram of a recommending device according to a third embodiment of the present disclosure, which in particular may include: a collecting module 501, an extracting module 502, an identification module 503, a first acquisition module 504 and a first display module 505.

Wherein the collecting module 501 can be configured to collect voice data of a current user.

The extracting module 502 can be configured to extract voiceprint features of the voice data.

The identification module 503 can be configured to identify the current user according to the voiceprint features.

The first acquisition module 504 can be configured to acquire program contents to be recommended to the current user according to behavioral habit features of the current user; wherein, the behavioral habit features include: Relative attributes of historical program contents obtained according to analysis of historical behavior data of the user.

The first display module 505 can be configured to display the program contents on a smart TV.

Wherein the identification module 503 in particular may include:

a matching degree calculating sub-module 5031, which can be configured to input the voiceprint features to a user's voiceprint feature model, and output, by the voiceprint feature model, a matching degree of the voiceprint features and the voiceprint feature model; wherein the voiceprint feature model is a model obtained according to user's voice data training; and

a determination sub-module 5032, which can be configured to determine a user corresponding to a voiceprint feature model that has a highest matching degree with the voiceprint features as the current user.

The recommending device disclosed in the embodiment of the present disclosure can identify the current user according to the voiceprint features extracted from the voice data of the current user, thereby recommending the current user of the smart TV program contents that match with his/her behavioral habit features. Wherein the matching degree calculating sub-module in the identification module can be configured to input the voiceprint features to a user's voiceprint feature model, and the voiceprint feature model outputs a matching degree of the voiceprint features and the voiceprint feature model; wherein the voiceprint feature model is a model obtained according to user's voice data training, and the determination sub-module in the identification module can be configured to determine a user corresponding to a voiceprint feature model that has a highest matching degree with the voiceprint features as the current user. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

### Device Embodiment IV

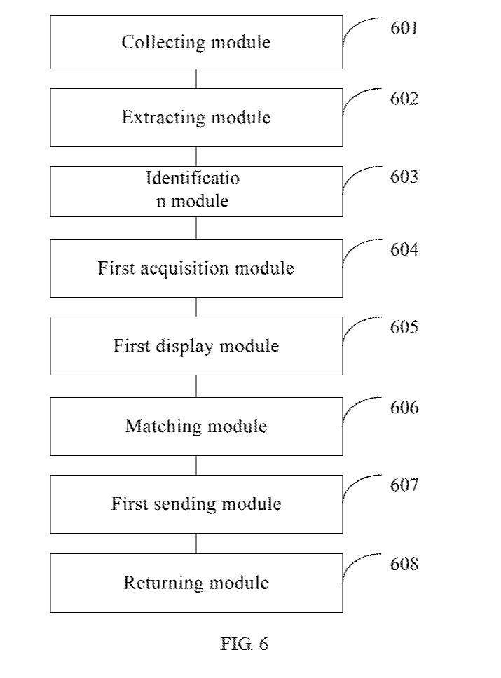

With reference to FIG. 6, it shows a schematic structural diagram of a recommending device according to a fourth embodiment of the present disclosure, which in particular may include: a collecting module 601, an extracting module 602, an identification module 603, a first acquisition module 604, a first display module 605, a matching module 606, a first sending module 607 and a returning module 608.

Wherein the collecting module 601 is positioned in a digital signal processor and can be configured to collect voice data of a current user.

The extracting module 602 can be configured to extract voiceprint features of the voice data.

The identification module 603 can be configured to identify the current user according to the voiceprint features.

The first acquisition module 604 can be configured to acquire program contents to be recommended to the current user according to behavioral habit features of the current user; wherein, the behavioral habit features include: relative attributes of historical program contents obtained according to analysis of historical behavior data of the user.

The first display module 605 can be configured to display the program contents on a smart TV.

The matching module 606 is positioned in the digital signal processor and can be configured to match the voice data with a preset boot-up instruction.

The first sending module 607 is positioned in the digital signal processor and can be such configured that, when the voice data matches with the preset boot-up instruction, the digital signal processor sends a request of booting up the smart TV to the smart TV to make the smart TV perform a power-on operation.

The returning module 608 is positioned in the digital signal processor and can be configured to cause the digital signal processor to return to perform the step of collecting the voice data of the current user when the voice data fails to match with the preset boot-up instruction.

The recommending device disclosed in the embodiment of the present disclosure can identify the current user according to the voiceprint features extracted from the voice data of the current user, thereby recommending the current user of the smart TV program contents that match with his/her behavioral habit features. Wherein the matching module is positioned in the digital signal processor and can be configured to match the voice data with the preset boot-up instruction; the first sending module is positioned in the digital signal processor and can be such configured that when the voice data matches with the preset boot-up instruction, the digital signal processor sends a request of booting up the smart TV to the smart TV to make the smart TV perform a power-on operation; the returning module is positioned in the digital signal processor and can be such configured that when the voice data fails to match with the preset boot-up instruction, the digital signal processor returns to perform the step of collecting the voice data of the current user. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

### Device Embodiment V

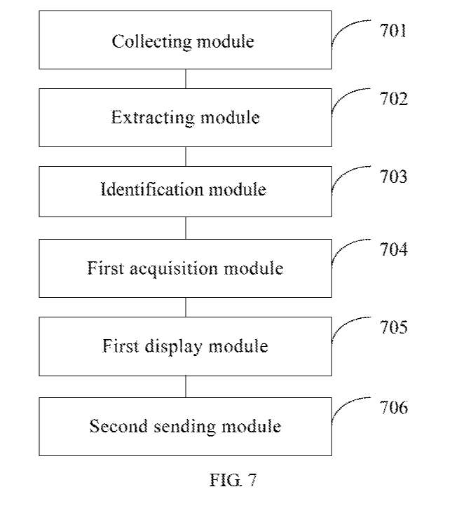

With reference to FIG. 7, it shows a schematic structural diagram of a recommending device according to a fifth embodiment of the present disclosure, which in particular may include: a collecting module 701, an extracting module 702, an identification module 703, a first acquisition module 704, a first display module 705 and a second sending module 706.

Wherein the collecting module 701 is positioned in a digital signal processor and can be configured to collect voice data of a current user.

The extracting module 702 can be configured to extract voiceprint features of the voice data.

The identification module 703 can be configured to identify the current user according to the voiceprint features.

The first acquisition module 704 can be configured to acquire program contents to be recommended to the current user according to behavioral habit features of the current user; wherein, the behavioral habit features include: relative attributes of historical program contents obtained according to analysis of historical behavior data of the user.

The first display module 705 can be configured to display the program contents on a smart TV.

The second sending module 706 is positioned in the digital signal processor and can be configured to send the voiceprint features to the smart TV after receiving a voiceprint feature request from the smart TV; wherein the smart TV sends the voiceprint feature request to the digital signal processor after completing the power-on operation.

The recommending device disclosed in the embodiment of the present disclosure can identify the current user according to the voiceprint features extracted from the voice data of the current user, thereby recommending the current user of the smart TV program contents that match with his/her behavioral habit features. Wherein the second sending module is positioned in the digital signal processor and can be configured to send the voiceprint features to the smart TV after receiving a voiceprint feature request from the smart TV wherein the smart TV sends the voiceprint feature request to the digital signal processor after completing the power-on operation. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

### Device Embodiment VI

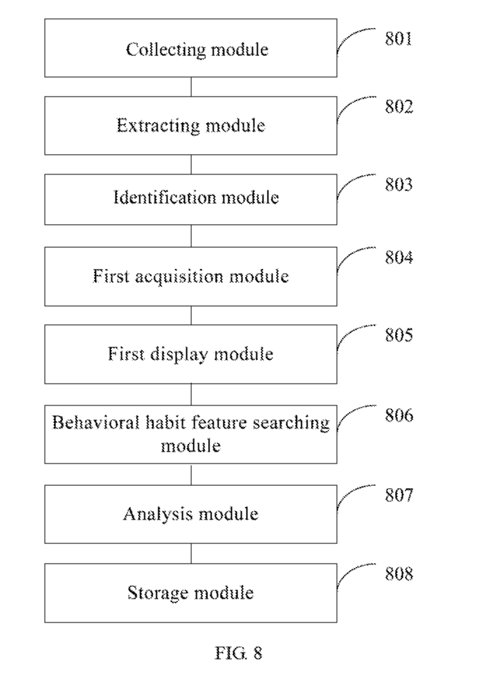

With reference to FIG. 8, it shows a schematic structural diagram of a recommending device according to a sixth embodiment of the present disclosure, which in particular may include: a collecting module 801, an extracting module 802, an identification module 803, a first acquisition module 804, a first display module 805, a behavioral habit feature searching module 806, an analysis module 807 and a storage module 808.

Wherein the collecting module 801 can be configured to collect voice data of a current user.

The extracting module 802 can be configured to extract voiceprint features of the voice data.

The identification module 803 can be configured to identify the current user according to the voiceprint features.

The first acquisition module 804 can be configured to acquire program contents to be recommended to the current user according to behavioral habit features of the current user; wherein, the behavioral habit features include: relative attributes of historical program contents obtained according to analysis of historical behavior data of the user.

The first display module 805 can be configured to display the program contents on a smart TV.

The behavioral habit feature searching module 806 can be configured to search for user's behavioral habit features corresponding to the current user in the behavioral habit database according to the current user; wherein the behavioral habit database is stored with a mapping relation between the user and the behavioral habit features.

Wherein the behavioral habit database is established by the following analysis module 807 and the storage module 808.

The analysis module 807 can be configured to obtain corresponding behavioral habit features according to the analysis of user's historical behavior data after the user is identified according to the voiceprint features.

The storage module 808 can be configured to store the mapping relation between the user and the behavioral habit features in the behavioral habit database.

The recommending device disclosed in the embodiment of the present disclosure can identify the current user according to the voiceprint features extracted from the voice data of the current user, thereby recommending the current user of the smart TV program contents that match with his/her behavioral habit features. Wherein the behavioral habit feature searching module can be configured to search for user's behavioral habit features corresponding to the current user in the behavioral habit database according to the current user; wherein the behavioral habit database is stored with a mapping relation between the user and the behavioral habit features; wherein the behavioral habit database is established by the analysis module and the storage module: the analysis module can be configured to obtain corresponding behavioral habit features according to the analysis of user's historical behavior data after the user is identified according to the voiceprint features; the storage module can be configured to store the mapping relation between the user and the behavioral habit features in the behavioral habit database. In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

### Device Embodiment VII

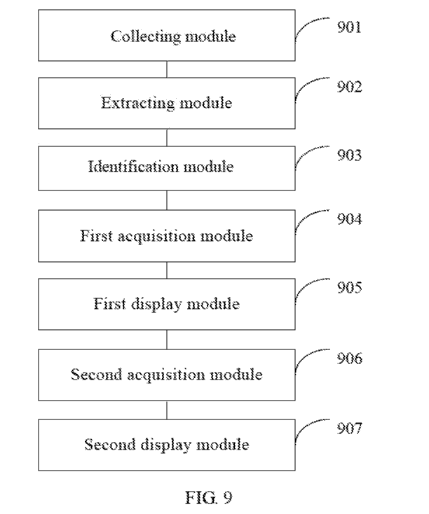

With reference to FIG. 9, it shows a schematic structural diagram of a recommending device according to a seventh embodiment of the present disclosure, which in particular may include: a collecting module 901, an extracting module 902, an identification module 903, a first acquisition module 904, a first display module 905, a second acquisition module 906 and a second display module 907.

Wherein the collecting module 901 can be configured to collect voice data of a current user.

The extracting module 902 can be configured to extract voiceprint features of the voice data.

The identification module 903 can be configured to identify the current user according to the voiceprint features.

The first acquisition module 904 can be configured to acquire program contents to be recommended to the current user according to behavioral habit features of the current user; wherein, the behavioral habit features include: relative attributes of historical program contents obtained according to analysis of historical behavior data of the user.

The first display module 905 can be configured to display the program contents on a smart TV.

In the embodiment of the present disclosure, the above described behavioral habit features in particular may further include: basic usage habit features of the current user with respect to the smart TV.

The second acquisition module 906 can be configured to acquire parameters of the smart TV to be recommended to the current user according to the basic usage habit features of the current user.

The second display module 907 can be configured to display the parameters on the smart TV. The recommending device disclosed in the embodiment of the present disclosure can identify the current user according to the voiceprint features extracted from the voice data of the current user, thereby recommending the current user of the smart TV program contents that match with his/her behavioral habit features. Wherein the first display module can be configured to display the program contents on the smart TV; the second display module can be configured to display the above described parameters on the smart TV; In contrast to the existing recommendation scheme wherein the smart TV acquires program contents to be recommended to the current user according to operations and browsing histories of all the previous users, the embodiment of the present disclosure can identify the current user according to the voiceprint features and then recommend different users program contents that match with their preferences according to their behavioral habit features, and therefore can increase the accuracy of the recommended program contents.

For device embodiments, since they are basically similar to the method embodiments, the description thereof is relatively simple, and for relative parts please refer to part of the description of the method embodiments.

Device embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. A person skilled in the art may understand and implement it without undertaking creative work.

Through the above description of embodiments, a person skilled in the art can clearly appreciate that, each embodiment can be achieved by means of software with necessary general hardware platform, and of course can also be achieved by hardware. Based on this appreciation, the above described technical solution essentially or the part that makes contribution to the prior art can be embodied in the form of software product, which can be stored in a computer readable storage medium such as ROM/RAM, magnetic disc and optical disc, including several commands configured to cause a computer equipment (which may be a personal computer, a server or a network equipment or the like) to execute the method described in each embodiment or some parts of the embodiments.

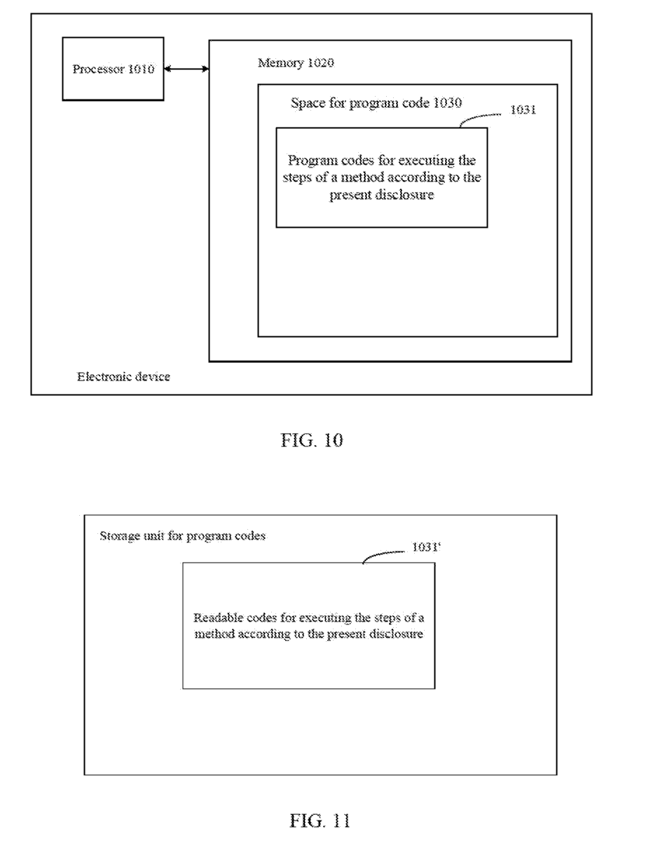

For example, FIG. 10 illustrates a block diagram of an electronic device for executing the method according the disclosure. The electronic device may be the smart TV above. Traditionally, the electronic device includes a processor 1010 and a computer program product or a computer readable medium in form of a memory 1020. The memory 1020 could be electronic memories such as flash memory. EEPROM (Electrically Erasable Programmable Read-Only Memory), EPROM, hard disk or ROM. The memory 1020 has a memory space 1030 for executing program codes 1031 of any steps in the above methods. For example, the memory space 1030 for program codes may include respective program codes 1031 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 11. The memory cells may be provided with memory sections, memory spaces, etc., similar to the memory 1020 of the electronic device as shown in FIG. 10. The program codes may be compressed for example in an appropriate form. Usually, the memory cell includes computer readable codes 1031′ which can be read for example by processors 1010. When these codes are operated on the electronic device, the electronic device may execute respective steps in the method as described above.

Finally, it should be noted that the foregoing embodiments are merely illustrative of technical solutions of the present disclosure without limitation; although the present disclosure is illustrated in detail with reference to the above embodiments, a person skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment. Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A recommending method, comprising:
at an electronic device:
collecting voice data of a current user;
extracting voiceprint features of the voice data;
identifying the current user according to the voiceprint features:
acquiring program contents to be recommended to the current user according to behavioral habit features of the current user; wherein the behavioral habit features comprise: relative attributes of historical program contents obtained according to analysis of historical behavior data of the user; and
displaying the program contents on a smart TV.

2. The method according to claim 1, wherein the step of identifying the current user according to the voiceprint features comprises:
searching for a user corresponding to the voiceprint features in a voiceprint database according to the voiceprint features; wherein the voiceprint database is stored with a mapping relation between the user and the voiceprint features.

3. The method according to claim 1, wherein the step of identifying the current user according to the voiceprint features comprises:
inputting the voiceprint features to a user's voiceprint feature model, and outputting, by the voiceprint feature model, a matching degree of the voiceprint features and the voiceprint feature model; wherein the voiceprint feature model is a model obtained according to user's voice data training; and
determining a user corresponding to a voiceprint feature model that has a highest matching degree with the voiceprint feature as the current user.

4. The method according to claim 1, wherein the step of collecting the voice data of the current user comprises: collecting, by a digital signal processor, the voice data of the current user;
before identifying the current user according to the voiceprint features, the method further comprising:
matching, by the digital signal processor, the voice data with a preset boot-up instruction;
when the voice data matches with the preset boot-up instruction, sending, by the digital signal processor, a request of booting up the smart TV to the smart TV to make the smart TV perform a power-on operation; and
when the voice data fails to match with the preset boot-up instruction, returning to perform, by the digital signal processor, the step of collecting the voice data of the current user.

5. The method according to claim 4, further comprising:
sending, by the digital signal processor, the voiceprint features to the smart TV after receiving a voiceprint feature request from the smart TV; wherein the smart TV sends the voiceprint feature request to the digital signal processor after completing the power-on operation.

6. The method according to claim 1, wherein before acquiring the program contents to be recommended to the current user according to the behavioral habit features of the current user, the method further comprises:
searching for user's behavioral habit features corresponding to the current user in the behavioral habit database according to the current user; wherein the behavioral habit database is stored with a mapping relation between the user and the behavioral habit features;
wherein the behavioral habit database is established by the following steps:
after identifying the user according to the voiceprint feature, obtaining corresponding behavioral habit features according to the analysis of the historical behavior data of the user; and
storing the mapping relation between the user and the behavioral habit features in the behavioral habit database.

7. The method according to claim 1, wherein the behavioral habit features further comprise: basic usage habit features of the current user with respect to the smart TV, the method further comprising:
acquiring parameters of the smart TV to be recommended to the current user according to the basic usage habit features of the current user; and
displaying the parameters on the smart TV.

8. An electronic device, comprising:
at least one processor, and
a memory communicably connected with the at least one processor for storing instructions executable by the at least one processor, wherein execution of the instructions by the at least one processor causes the at least one processor to:
collect voice data of a current user;
extract voiceprint features of the voice data;
identify the current user according to the voiceprint features;
acquire program contents to be recommended to the current user according to behavioral habit features of the current user; wherein, the behavioral habit features comprise: relative attributes of historical program contents obtained according to analysis of historical behavior data of the user; and
display the program contents on a smart TV.

9. The electronic device according to claim 8, wherein identify the current user according to the voiceprint features comprises:
search for a user corresponding to the voiceprint features in a voiceprint database according to the voiceprint features; wherein the voiceprint database is stored with a mapping relation between the user and the voiceprint features.

10. The electronic device according to claim 8, wherein identify the current user according to the voiceprint features comprises:
input the voiceprint features to a user's voiceprint feature model, and output, by the voiceprint feature model, a matching degree of the voiceprint feature and the voiceprint feature model; wherein the voiceprint feature model is a model obtained according to user's voice data training; and
determine a user corresponding to a voiceprint feature model that has a highest matching degree with the voiceprint features as the current user.

11. The electronic device according to claim 8, wherein collect voice data of a current user is positioned in a digital signal processor, execution of the instructions by the at least one processor causes the at least one processor to:
match the voice data with a preset boot-up instruction;
send, when the voice data matches with the preset boot-up instruction, a request of booting up the smart TV to the smart TV to make the smart TV perform a power-on operation; and
cause the digital signal processor to return to perform the step of collecting the voice data of the current user when the voice data fails to match with the preset boot-up instruction.

12. The electronic device according to claim 11, wherein execution of the instructions by the at least one processor causes the at least one processor to:
send the voiceprint features to the smart TV after receiving a voiceprint feature request from the smart TV; wherein the smart TV sends the voiceprint feature request to the digital signal processor after completing the power-on operation.

13. A non-transitory computer-readable storage medium storing executable instructions that, when executed by an electronic device with a touch-sensitive display, cause the electronic device to:
collect voice data of a current user;
extract voiceprint features of voice data;
identify the current user according to the voiceprint features:
acquire program contents to be recommended to the current user according to behavioral habit features of the current user, wherein, the behavioral habit features comprise: relative attributes of historical program contents obtained according to analysis of historical behavior data of the user; and
display the program contents on a smart TV.

14. The non-transitory computer-readable storage medium according to claim 13, wherein identify the current user according to the voiceprint features comprises:
searching for a user corresponding to the voiceprint features in a voiceprint database according to the voiceprint features; wherein the voiceprint database is stored with a mapping relation between the user and the voiceprint features.

15. The non-transitory computer-readable storage medium according to claim 13, wherein identify the current user according to the voiceprint features comprises:
inputting the voiceprint features to a user's voiceprint feature model, and outputting, by the voiceprint feature model a matching degree of the voiceprint features and the voiceprint feature model; wherein the voiceprint feature model is a model obtained according to user's voice data training; and
determining a user corresponding to a voiceprint feature model that has a highest matching degree with the voiceprint feature as the current user.

16. The non-transitory computer-readable storage medium according to claim 13, wherein collect the voice data of the current user comprises:
collecting, by a digital signal processor, the voice data of the current user;
before identify the current user according to the voiceprint features, the electronic device is further caused to:
match, by the digital signal processor, the voice data with a preset boot-up instruction;
when the voice data matches with the preset boot-up instruction, send, by the digital signal processor, a request of booting up the smart TV to the smart TV to make the smart TV perform a power-on operation; and
when the voice data fails to match with the preset boot-up instruction, return to perform, by the digital signal processor, collecting the voice data of the current user.

17. The non-transitory computer-readable storage medium according to claim 16, wherein the electronic device is further caused to:
send, by the digital signal processor, the voiceprint features to the smart TV after receiving a voiceprint feature request from the smart TV; wherein the smart TV sends the voiceprint feature request to the digital signal processor after completing the power-on operation.

18. The non-transitory computer-readable storage medium according to claim 13, wherein before acquire the program contents to be recommended to the current user according to the behavioral habit features of the current user, the electronic device is further caused to:
search for user's behavioral habit features corresponding to the current user in the behavioral habit database according to the current user; wherein the behavioral habit database is stored with a mapping relation between the user and the behavioral habit features;
wherein the behavioral habit database is established by:
after identifying the user according to the voiceprint feature, obtaining corresponding behavioral habit features according to the analysis of the historical behavior data of the user; and
storing the mapping relation between the user and the behavioral habit features in the behavioral habit database.

19. The non-transitory computer-readable storage medium according to claim 13, wherein the behavioral habit features further comprise: basic usage habit features of the current user with respect to the smart TV, the electronic device is further caused to:
acquire parameters of the smart TV to be recommended to the current user according to the basic usage habit features of the current user, and
display the parameters on the smart TV.
